(19) United States
(12) Patent Application Publication
(10) Pub. No.: US 2005/0218371 A1
(43) Pub. Date: Oct. 6, 2005

(54) Heat transfer fluids and methods of making and using same

(76) Inventor: Frederick W. Giacobbe, (US)

Correspondence Address: Linda K. Russell;Intellectual Property Department, Air Liquide, Suite 1800, 2700 Post Oak Boulevard, Houston, TX, 77056, US

(21) Appl. No.: 11/130,331

(22) Filed: May 17, 2005

Related U.S. Application Data
(62) Division of application No. 10/004,061, filed on Oct. 31, 2001, now abandoned.
(60) Provisional application No. 60/278,662, filed on Mar. 20, 2001.

(51) Int. Cl. C09K 3/18

(52) U.S. Cl. 252/70

(57) ABSTRACT

Heat transfer fluid mixtures and methods of making and using same are presented. The inventive heat transfer fluid mixtures consist essentially of at least one light gas, such as helium, and at least one heavy fluid, such as argon, which may be adjusted between a first composition having a high heat transfer coefficient and high cost, and a second composition of a lower cost.

### CROSS-REFERENCE TO RELATED APPLICATIONS

This application claims priority from provisional patent application Ser. No. 60/278,662, Mar. 20, 2001, which is incorporated by reference herein.

### BACKGROUND OF THE INVENTION

1. Field of the Invention

This invention relates to novel compositions and their use as heat transfer fluids in a variety of applications.

2. Related Art

Pure or relatively pure helium has excellent heat transfer properties. For example, helium is typically employed to enhance fiber cooling during the optical fiber drawing process because it is chemically inert and because of its heat transfer properties. Of the common pure gases, only hydrogen has a higher thermal conductivity than pure helium. However, hydrogen is not as inert as helium and it is more hazardous to employ in certain gases related heat transfer applications than any inert gas. So, hydrogen is typically avoided as a gaseous heat transfer medium in some (but not all) cooling or heating process applications.

Typical impurities in the helium used in heat transfer processes are due to minor impurities initially present within the source of “pure” helium as well as contamination by infiltration of other species into the helium that is used to transfer heat between the helium and the item or material being cooled or heated. These impurities often consist primarily of nitrogen and oxygen with much smaller concentrations of argon, carbon dioxide, and water vapor as well as even smaller concentrations of other gaseous constituents normally found in air. These impurities are generally tolerated because they are difficult and/or costly to avoid, but they are not purposely introduced into the helium.

It is generally accepted that binary mixtures of helium (or hydrogen) with other gases will have better heat transfer coefficients than the pure gases themselves. See, for example, M. R. Vanco, “Analytical Comparison of Relative Heat-Transfer Coefficients and Pressure Drops of Inert Gases and Their Binary Mixtures, NASA TN D2677 (1965); F. W. Giacobbe, “Heat Transfer Capability of Selected Binary Gaseous Mixtures Relative to Helium and Hydrogen”, Applied Thermal Engineering Vol. 18, Nos. 3-4, pp. 199-206 (1998); R. Holoboffet al., “Gas Quenching With Helium”, Advanced Materials & Processes, Vol. 143, No. 2, pp. 23-26 (1993). In particular, Holoboff et al. noted that in the context of a heat treating furnace, by changing to an optimum helium/argon mixture, a customer was able to heat treat parts that could not be processed as rapidly when using argon alone, while maintaining costs at a fraction of that for using 100% helium. In a separate example the same authors also recognized the benefits of increasing the fan speed (gas circulation velocity) on specimen cooling rates when using pure helium or pure nitrogen in cooling applications. However, there is no teaching or suggestion of the influence of heat transfer fluid mixture velocity on cooling rate for optimized mixtures of heat transfer fluid.

For illustrative purposes, and according ot earlier theories, the relative heat transfer capability of helium plus one other noble gas compared to pure helium may be seen in FIG. 1. In FIG. 1, pure helium has been arbitrarily assigned a relative heat transfer capability of 1.0 in order to deliberately avoid the use of a more complicated system of SI heat transfer units. Therefore, if a binary gas mixture containing helium has a heat transfer capability of 2.0 (relative to pure helium), it is assumed from this data that gas mixture will be 2.0 times more effective in any heat transfer process employing that gaseous mixture instead of pure helium alone. And, as a simplified illustration of the potential helium savings using this data, if the best binary gas mixture contained only 50 percent (by volume or mole fraction) helium plus 50 percent of some other gas, only ½ of that gas mixture would be needed to perform the same cooling function as the pure helium alone. Therefore, only 25 percent of the helium that would have been required for a particular heat exchange process using pure helium would be needed during the same cooling process employing the gas mixture.

In FIG. 2, and also according to earlier theories, the optimum composition and approximate relative heat transfer capability of hydrogen plus one noble gas with respect to pure helium is illustrated. In FIG. 2, pure helium has also been arbitrarily assigned a relative heat transfer capability of 1.0. So, if a binary gas mixture containing only hydrogen and argon (but no helium) has a heat transfer capability of 1.4 (relative to pure helium), that gas mixture presumably will be 1.4 times more effective in any heat transfer process employing that gaseous mixture instead of pure helium alone. And, since no helium is required to produce this effect, the helium usage is cut to zero. Furthermore, since hydrogen and argon are typically much less expensive than helium, the overall cost of the hydrogen/argon coolant gas stream will tend to be negligible compared to a pure (or relatively pure) helium coolant gas steam.

It should be emphasized that the data presented in FIGS. 1 and 2 are theoretical and based on turbulent flow for all gases and gas mixtures considered. However, in the seminal work of R. B. Bird, W. E. Stewart, and E. N. Lightfoot, Transport Phenomena, pp. 392-393 (1960) it was pointed out that “the heat-transfer coefficient depends in a complicated way on many variables, including the fluid properties (k, μ, ρ, Cₚ), the system geometry, the flow velocity, the value of the characteristic temperature difference, and the surface temperature distribution.” In engineering design, therefore, use of constant property idealization frequently leads to either a greater built in safety factor, or a dangerous situation if the other extreme is taken. See D. M. McEligot, et al., “Internal Forced Convection to Mixtures of Inert Gases”, Int. J. Heat Mass Transfer, Vol. 20, pp. 475-486 (1977).

Everyone agrees that helium is an expensive fluid. While it is inert, it is a non-renewable resource. Once it escapes to the atmosphere it is not recoverable. Helium is commonly recycled, sometimes after purification, such as described in U.S. Pat. Nos. 5,897,682 and 6,092,391. However, this requires expensive compression and/or cryogenic equipment. Indeed, as noted by K. Bammert et al., “The Influence of He—Ne, He—N₂, and He—CO₂ Gas Mixtures on Closed-Cycle Gas Turbines”, ASME paper 74-GT-124 (1974), while pure helium is often considered the best gaseous fluid in terms of heat transfer efficiency (except for pure hydrogen) and therefore heat exchange units may be particularly compact, the size of compression equipment required to compress the gas is prohibitive in many applications, such as space travel. Thus, the expense of the heat transfer fluid (helium) is combined with a relatively large expense for compression equipment, even though heat transfer equipment may be smaller.

In light of the unexpected nature of heat transfer coefficients of fluids, it would be advantageous in many heat transfer situations common in engineering to employ a heat transfer fluid mixture that can easily be changed in composition to take advantage of the heat transfer properties of helium and/or hydrogen, without the great expense of pure helium and the expensive equipment needed to compress helium, while taking advantage of velocity effects on improvements in heat transfer performance.

### SUMMARY OF THE INVENTION

In accordance with the present invention, compositions consisting essentially of helium and other gases (or hydrogen and other gases), that can be advantageously employed in heat transfer applications, such as glass fiber cooling applications, are described which significantly reduce the cost of using pure helium while providing nearly the same heat transfer as pure helium. It has been discovered, quite unexpectedly, that heat transfer fluid mixtures consisting essentially of at least one light gas, for example helium, and at least one heavy gas, such as argon, when flowing past a heat transfer surface at very low bulk velocity or very high bulk velocity, exhibit heat transfer coefficients that are less than but close to that of the pure light gas (for example pure helium) flowing at the same bulk velocity. Therefore, while compositions of the invention might require slightly more heat transfer area than pure helium to achieve the same characteristic temperature difference in a fluid being heated or cooled, since the inventive compositions are much less expensive than pure helium, there is an opportunity for overall cost savings. Alternatively, if the designer allows for a slightly higher characteristic temperature difference, no change in heat transfer area is required. Furthermore, due to significant improvements in the heat transfer coefficients of these gas mixtures over substantially pure helium or substantially pure hydrogen when flowing at bulk velocities between very low and very high bulk velocity, the heat transfer designer may decide to use the inventive compositions and vary a parameter, such as concentration, bulk velocity, system pressure, characteristic temperature difference, and the like, to suit high demand time periods. For example, during times of high cool air demand in the summer months, a refrigeration unit employing one of the compositions may vary the concentration ratio of gases and the bulk velocity to achieve a higher characteristic temperature difference (better cooling).

As used herein the term “cooling” includes freezing. The term “heating” includes boiling, vaporizing, and the like. The term “fluid” is used for the heavy component to denote that at some temperatures and pressures, heavy components, such as CFCs, may have liquid and gas phases present.

A first aspect of the invention is a heat transfer fluid mixture consisting essentially of at least one light gas and at least one heavy gas, each of the at least one heavy gases having a molecular weight at least two times that of each of the at least one light gas, preferably at least ten times the light gas. Preferably the at least one light gas has a molecular weight less than 10, and the at least one heavy fluid has a molecular weight greater than 10. Preferred heat transfer fluid mixtures are those wherein the at least one light gas is hydrogen and the at least one heavy gas is helium; those wherein the at least one light gas is selected from the group consisting of hydrogen, helium, and mixtures thereof; those wherein the at least one light gas is hydrogen and the at least one heavy gas is selected from the group consisting of helium, any single fluid heavier than helium, and any mixture thereof; and those wherein the at least one light gas is selected from the group consisting of hydrogen, helium, and any mixture thereof, and the heavy gas is selected from the group consisting of argon, any single fluid heavier than helium, and any mixture of fluids heavier than helium.

The inventive heat transfer fluid mixtures preferably have the at least one light gas present at a concentration ranging from about 20 mole percent to about 99 mole percent; more preferably ranging from about 30 mole percent to about 98 mole percent; more preferably ranging from about 40 mole percent to about 97 mole percent. Particularly preferred heat transfer fluid mixtures are those wherein the at least one light gas has a concentration ranging from about 50 mole percent to about 96 mole percent, and those wherein the at least one light gas has a concentration ranging from about 60 mole percent to about 95 mole percent.

Preferred heavy gases useful in the invention include those selected from the group consisting of N₂, O₂, F₂, Ne, Cl₂, Ar, Br₂, Kr, Xe, Rn, CH₄, C₂H₄, C₂H₆, C₃H₈, C₃H₆, C₄H₁₀, (CH₃)₃CH, NH₃, CO, CO₂, CCl₄, CH₃Cl, SO₂, SO₃, NO, NO₂, N₂O, CCl₃F, CCl₂F₂, CClF₃, CBrF₃, CF₄, CHCl₂F, CHClF₂, CHF₃, C₂Cl₄F₂, C₂Cl₃,F₃, C₂Cl₂F₄, C₂Br₂F₄, C₂ClF₅, C₂F₆, C₂H₄F₂, C₂H₂F₄ and mixtures thereof. Particularly preferred are those compositions wherein the each of the at least one heavy gases has molecular weight at least five times that of each of the at least one light gas.

A second aspect of the invention is a method of cooling an item, the method comprising contacting the item with one of the heat transfer fluid mixtures of the invention, wherein the contacting is selected from the group consisting of directly contacting, indirectly contacting, and combinations thereof.

A third aspect of the invention is a method of heating an item, the method comprising contacting the item with one of the heat transfer fluid mixtures of the invention, wherein the contacting is selected from the group consisting of directly contacting, indirectly contacting, and combinations thereof.

A fourth aspect of the invention is a method of cooling an item traversing through a substantially confined space, the method comprising contacting the item with a heat transfer fluid mixture of the invention, wherein the contacting is selected from the group consisting of directly contacting, indirectly contacting, and combinations thereof.

A fifth aspect of the invention is a method of heating an item traversing through a substantially confined space, the method comprising contacting the item with a heat transfer fluid mixture of the invention, wherein the contacting is selected from the group consisting of directly contacting, indirectly contacting, and combinations thereof.

A sixth aspect of the invention is a method of cooling a substantially cylindrical item traversing through a substantially confined space, the method comprising contacting the substantially cylindrical item with a heat transfer fluid mixture of the invention, wherein the contacting is selected from the group consisting of directly contacting, indirectly contacting, and combinations thereof.

A seventh aspect of the invention is a method of heating a substantially cylindrical item traversing through a substantially confined space, the method comprising contacting the substantially cylindrical item with a heat transfer fluid mixture of the invention, wherein the contacting is selected from the group consisting of directly contacting, indirectly contacting, and combinations thereof.

An eighth aspect of the invention is a method of cooling a substantially cylindrical optical fiber traversing through a heat exchanger, the method comprising contacting the optical fiber with a heat transfer fluid mixture of the invention, wherein the contacting is selected from the group consisting of directly contacting, indirectly contacting, and combinations thereof.

A ninth aspect of the invention is a method of improving the cooling of a substantially cylindrical optical fiber traversing through a heat exchange device, the method comprising the steps of contacting (either directly, indirectly, or combination thereof) the optical fiber with a heat transfer fluid mixture consisting essentially of at least one light gas and at least one heavy gas, and making an adjustment (either intermittently or continuously) of a parameter during the cooling, the parameter selected from the group consisting of composition of the heat transfer fluid mixture, flow rate of the heat transfer fluid mixture into the heat exchange device, an amount of heat transfer fluid mixture contacting the fiber in counter-current fashion, an amount of heat transfer fluid mixture contacting the fiber in co-current fashion, composition of the heat transfer fluid mixture contacting the fiber in counter-current fashion, composition of the heat transfer fluid mixture contacting the fiber in co-current fashion, a temperature of the heat transfer fluid mixture being injected into the heat exchange device, a temperature of the heat transfer fluid mixture before contacting the fiber in counter-current fashion, a temperature of the heat transfer fluid mixture during contacting the fiber in counter-current fashion, a temperature of the heat transfer fluid mixture after contacting the fiber in counter-current fashion, a temperature of the heat transfer fluid mixture before contacting the fiber in a co-current fashion, a temperature of the heat transfer fluid mixture during contacting the fiber in a co-current fashion, a temperature of the heat transfer fluid mixture after contacting the fiber in a co-current fashion, a pressure of the heat transfer fluid mixture injected into the heat exchange device, a pressure of the heat transfer fluid mixture contacting the fiber in countercurrent fashion, and a pressure of the heat transfer fluid mixture contacting the fiber in a co-current fashion.

A tenth aspect of the invention is a method of improving cooling of an object in contact with a stagnant or flowing gas mixture in a confined space, the method comprising contacting (directly, indirectly or combination thereof) the object with a heat transfer fluid mixture consisting essentially of at least one light gas and at least one heavy gas, and making an adjustment (either intermittently or continuously) of a parameter during the cooling process, the parameter selected from the group consisting of a composition of the heat transfer fluid mixture, a flow rate of the heat transfer fluid mixture in contact with the object, an amount of heat transfer fluid mixture contacting the object, a composition of the heat transfer fluid mixture contacting the object, a temperature of the heat transfer fluid injected into the confined space, a temperature of the heat transfer fluid mixture before contacting the object, a temperature of the heat transfer fluid mixture during contacting the object, a temperature of the heat transfer fluid mixture after contacting the object, a pressure of the heat transfer fluid mixture entering the confined space, and a pressure of the heat transfer fluid mixture contacting the object. One particularly preferred embodiment is that wherein the parameter adjustment is made automatically or manually based upon a measured parameter of the object that changes during the cooling process.

An eleventh aspect of the invention is a method of improving heating of an object in contact with a stagnant or flowing gas mixture in a confined space, the method comprising contacting (directly, indirectly or combination thereof) the object with a heat transfer fluid mixture consisting essentially of at least one light gas and at least one heavy gas, and making an adjustment (either intermittently or continuously) of a parameter during the heating process, the parameter selected from the group consisting of a composition of the heat transfer fluid mixture, a flow rate (or bulk velocity) of the heat transfer fluid mixture in contact with the object, an amount of heat transfer fluid mixture contacting the object, a composition of the heat transfer fluid mixture contacting the object, a temperature of the heat transfer fluid injected into the confined space, a temperature of the heat transfer fluid mixture before contacting the object, a temperature of the heat transfer fluid mixture during contacting the object, a temperature of the heat transfer fluid mixture after contacting the object, a pressure of the heat transfer fluid mixture entering the confined space, and a pressure of the heat transfer fluid mixture contacting the object. A particularly preferred method is that wherein the parameter adjustment is made automatically or manually based upon a measured parameter of the object that changes during the heating process.

A twelfth aspect of the invention is a method of making a heat transfer fluid, the heat transfer fluid adjustable between a first composition having high heat transfer coefficient and high cost of use, and a second composition having essentially the same heat transfer coefficient as the first composition but allowing reduced cost of use, the method comprising the steps of:
a) providing at least one light gas from a light gas source;
b) providing at least one heavy gas from a heavy gas source;
c) ascertaining a heating or cooling demand;
d) combining the at least one light gas and the at least one heavy gas based on the demand.

Preferred are those methods wherein each of the at least one heavy gases has a molecular weight at least two times that of each of the at least one light gas; methods wherein the light gas is selected from the group consisting of hydrogen, helium, and any mixture thereof, and the heavy gas is selected from the group consisting of argon, any single fluid heavier than helium, and any mixture of gases heavier than helium; and methods wherein the at least one heavy fluid is selected from the group consisting of N₂, O₂, F₂, Ne, Cl₂, Ar, Br₂, Kr, Xe, Rn, CH₄, C₂H₄, C₂H₆, C₃H₈, C₃H₆, C₄H₁₀, (CH₃)₃CH, NH₃, CO, CO₂, CCl₄, CH₃Cl, SO₂, SO₃, NO, NO₂, N₂O, CCl₃F, CCl₂F₂, CClF₃, CBrF₃, CF₄, CHCl₂F, CHClF₂, CHF₃, C₂Cl₄F₂, C₂Cl₃,F₃, C₂Cl₂F₄, C₂Br₂F₄, C₂ClF₅, C₂F₆, C₂H₄F₂, C₂H₂F₄, and mixtures thereof. Other preferred methods are those wherein the heat transfer fluid mixture composition and/or bulk velocity is adjusted after checking if heating or cooling demand is being met, and if so, whether the demand is being met within acceptable cost limits.

### BRIEF DESCRIPTION OF THE DRAWING FIGURES

FIGS. 1 and 2 illustrate the conventional belief that mixtures of helium with another noble gas, and mixtures of hydrogen with another noble gas, are always more effective heat transfer fluids;

FIG. 3A illustrates schematically an apparatus used to generate experimental data depicted graphically in FIGS. 3 and 4;

FIG. 3 illustrates graphically experimental data useful in the invention for helium/argon heat transfer fluid mixtures;

FIG. 4 illustrates graphically experimental data useful in the invention for helium/carbon dioxide heat transfer fluid mixtures; and

FIG. 5 illustrates a logic diagram useful in understanding the methods of the invention applied to a process of cooling an item such as an optical fiber.

### DESCRIPTION OF PREFERRED EMBODIMENTS

Studies performed in our laboratories using gases showed that the heat transfer coefficient of gas mixtures varies with bulk velocity of the gas, and that there are certain mixtures of light gases and heavy gases that, at highly laminar and highly turbulent flow regimes, have poorer heat transfer properties than the pure light gas. However, it was determined that the heat transfer coefficients for gases containing a relatively high concentration of at least one “light gas” plus at least one “heavy gas” are higher than the heat transfer coefficient of the individual gas stream within a specific range of bulk velocities, referred to herein as the “critical bulk velocity range.” Above or below this range of critical bulk velocities, the light gas stream will have a higher heat transfer coefficient. As used herein, the words “light gas” and “heavy gas” refer (respectively) to a low molecular weight gas and a high molecular weight gas. The term fluid means either gas, liquid, or combination of gas and liquid. For example, two typical low molecular weight gases are hydrogen (MW approx.=2.0 g/mol) and helium (MW approx.=4.0 g/mol). Two typical high molecular weight noble gases are xenon (MW approx.=131 g/mol) and radon (MW approx.=222 g/mol). Furthermore, preferred heat transfer fluid mixtures of the invention are binary gaseous mixtures containing the lightest possible “light gas” and the heaviest possible “heavy gas”, in just the right concentrations relative to each other, since these mixtures typically have the highest possible coefficients of heat transfer (i.e., for cooling or heating purposes, they are the best gaseous heat transfer mediums) within the “critical bulk velocity range.”

For binary gas mixtures containing hydrogen or helium, the best noble gas to mix with the hydrogen or helium (for heat transfer purposes) is radon. Other non-noble gases (such as SF₆, UF₆, and many of the heavy inorganic or organic gases (for example CFC-type gases, as well as many other specific gases) can also be mixed with light gases such as hydrogen or helium to produce heat transfer fluid mixtures having very good heat transfer properties. However, radon is radioactive and very rare (thus very expensive) and many gases other than those in the noble gas family tend to be unstable (with respect to decomposition) at high temperatures. Although it is not intended to rule out the possible use of heavy gases such as radon, or other heavy gases outside those within the noble gas family for use in preparing gaseous heat transfer mixtures (such as SF₆, UF₆, and the like), these heat transfer fluids are only preferred in certain heat transfer applications. For example, where some radioactive material can be tolerated, for example, in a nuclear reactor, radioactive radon may be employed as a heavy gas in the inventive heat transfer fluid mixtures.

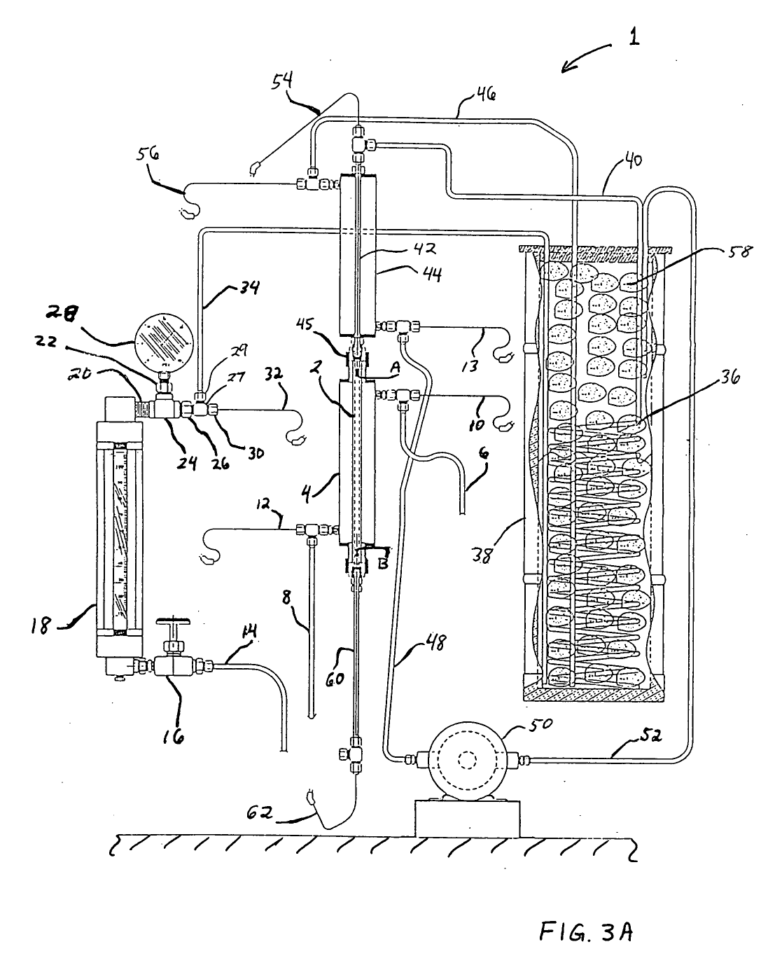

In accordance with the present invention, and as mentioned previously, the inventor herein has discovered that certain mixtures of light gases and heavy gases may be employed that have substantially the same or better heat transfer properties (cooling or heating ability) as pure light or pure heavy fluids. In particular, by simply measuring the bulk velocity of the heat transfer fluid mixture, a characteristic temperature difference of the system (either the mixture or the item being heated or cooled) and the heating or cooling demand, significant cost savings may be realized by the operator of the process or equipment utilizing the inventive heat transfer fluid mixtures. This may be seen by reviewing the data in FIG. 3. The curves in FIG. 3 were developed in the laboratory of the inventor using a laboratory set-up similar to that illustrated in FIG. 3A, which is now discussed.

Illustrated in FIG. 3A is an apparatus 1, having a copper tube 2 positioned concentrically within an outer stainless steel tube 4. There was thus a chamber between the inside surface of tube 4 and the outside surface of tube 2. Into this chamber was delivered steam through a steam inlet conduit 6 and steam exit conduit 8 sufficient to keep the inside and outside surfaces of tube 2 maintained at nearly 1001C. Copper tube 2 had a length between points A and B of about 9.4 inches (24 cm) between two thermocouples located in the center of the gas stream flowing there through. Copper tube 2 was 0.25 inch (0.64 cm) inside diameter, and about 0.5 inch (1.3 cm) outside diameter. Thermocouples 10 and 12 measured the temperature of entering and exiting steam, respectively, while thermocouples 54 and 62 measured temperature of inlet and outlet gas streams, respectively. Premixed helium/argon gas streams tested entered tube 2 at nearly 0° C. by virtue of having been cooled by an ice bath prior to entering tube 2, and all gases entered the tube at approximately 1 atmosphere pressure. Premixed gas streams entered apparatus 1 through a conduit 14 and valve 16, passing then through a gas flow rotameter as illustrated, although other types of gas flow meters could have been used just as well. Gas streams then passed through a screwed fitting 20, tee 24, and fitting 26. A gas pressure guage 28, connected via a fitting 22, allowed observation of pressure of the gas stream exiting flow meter 18. A smaller tee 27 and fitting 29 allowed connection of a conduit 34, and a fitting 30 allowed a thermocouple 32 to monitor temperature of the gas stream leaving flow meter 18. Conduit 34 allowed the gas stream to pass through a coil 36 which was submerged in an ice bath (about 0° C.) maintained in an insulated vessel 38. After passing through coil 36 the gas stream, now cooled to about 0° C., passes through a conduit 40. Since the gas stream picks up some heat from the ambient while passing through conduit 40, the apparatus 1 included a tube 42 which was enclosed in an outer shell 44. A series of fittings 45 connected tube 42 to copper tube 2, with thermocouple 54 positioned centrally in both tubes. Cold water from the ice bath in vessel 38 was pumped using a pump 50 through a conduit 48, into the chamber created between outer shell 44 and tube 42. Temperature of the cold water was monitored by another thermocouple 13. After being slightly warmed (as evidenced by a thermocouple 56) by indirect heat exchange with the gas stream flowing countercurrently through tube 42, the water was returned to vessel 38 through conduit 46. Pump 50 was provided with cold water from vessel 38 through another conduit 52. Gas temperature flowing between points A and B in copper tube 2 was monitored at various flow rates and gas compositions.

As can be seen in FIG. 3 for the helium/argon heat transfer fluid mixture, where helium is the light gas and argon the heavy fluid, at a bulk velocity through the tube below about 60 SCFH, the heat transfer fluid mixtures all had poorer heat transfer coefficients (as measured by the characteristic temperature difference defined as the temperature increase of the fluid) than pure helium. However, FIG. 3 also shows that at bulk flow rates between about 90 SCFH and 250 SCFH, mixtures of helium and argon, containing more than about 60 mole percent helium, performed almost as well as, or better than, pure helium alone.

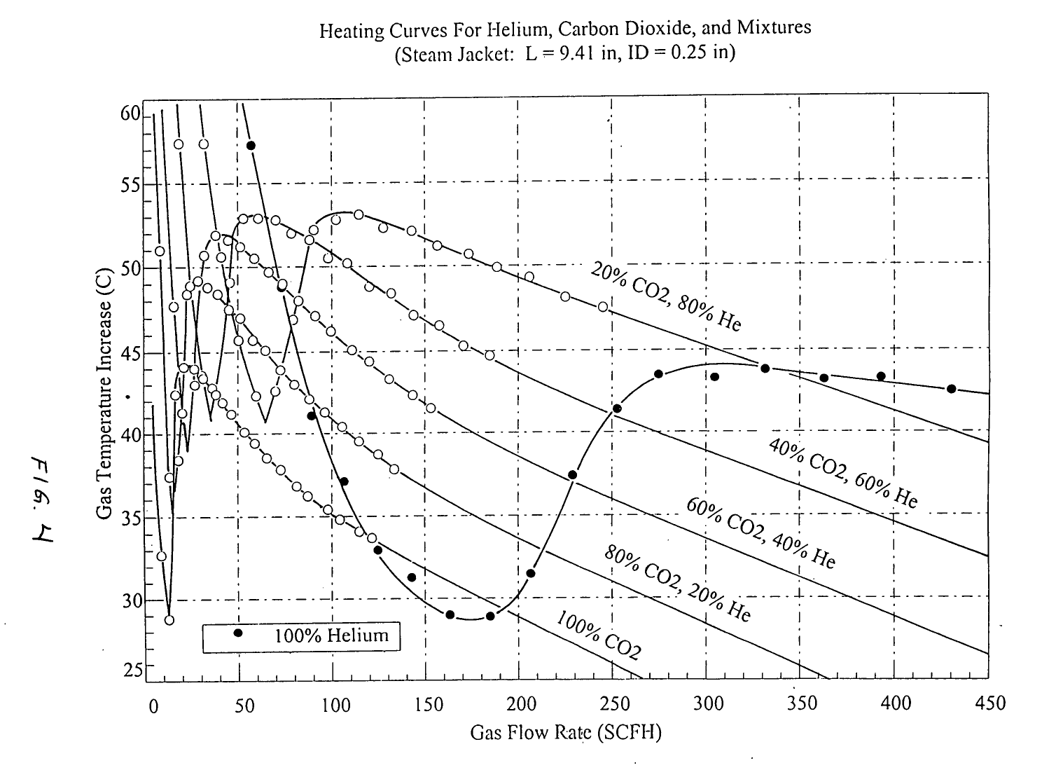

FIG. 4 is a similar analysis for mixtures of carbon dioxide and helium, using the same apparatus illustrated in FIG. 3A. Notice that at flow rates below about 250 SCFH, and above about 80 SCFH, mixtures of helium and carbon dioxide containing at least 60 mole percent helium performed as well as or better than pure helium.

Further testing of other binary mixtures, as well as tertiary mixtures, and mixtures having more than three components, have revealed similar behavior. For example, many combinations of a specific light gas plus specific heavy gas (in some optimum mixture ratio) have been surprisingly shown to exhibit almost as good or better heat transfer properties as the light gas alone. However, the choice of the actual gases to be employed will depend primarily upon the high and low temperatures that the inventive heat transfer fluid mixtures are likely to experience during the heat exchange process, the flow rates (bulk velocity) and pressure of the system, and last but not least, cost efficiency.

Preferred heavy gases are selected from the group consisting of N₂, O₂, F₂, Ne, Cl₂, Ar, Br₂, Kr, Xe, Rn, CCl₃F, CCl₂F₂, CClF₃, CBrF₃, CF₄, CHCl₂F, CHClF₂, CHF₃, C₂Cl₄F₂, C₂Cl₃,F₃, C₂Cl₂F₄, C₂Br₂F₄, C₂ClF₅, C₂F₆, C₂H₄F₂, C₂H₂F₄, CH₄, C₂H₄, C₂H₆, C₃H₈, C₃H₆, C₄H₁₀, (CH₃)₃CH, NH₃, CO, CO₂, CCl₄, CH₃Cl, SO₂, SO₃, NO, NO₂, N₂O, and mixtures thereof.

Mixing of light gases with heavy gases (which may be in mixed gas/liquid state) may be done by any number of means and is not critical to the present invention. One process and apparatus is described in U.S. Pat. No. 4,166,799, incorporated by reference herein. In the process of this patent, a carrier gas (such as nitrogen or carbon dioxide), relatively chemically inert with respect to the normally liquid chemical material, is passed through a pressure regulator into a tank containing the heavy gas. The tank is partially filled with a normally liquid chemical material. The carrier gas is distributed below the surface of the liquid causing the carrier gas to become appreciably saturated with vapor of the normally liquid material. The temperature of the tank contents are controlled to provide a predetermined exit gas temperature. As the level of the liquid is reduced by volatilization, the liquid level is preferably maintained by adding more liquid. Before exiting the tank, since the gas throughput is high, for example in excess of 50 standard cubic feet per hour, the residence time tends to be less than that which could be expected to readily achieve vapor-liquid equilibrium, based upon the degree of gas dispersion which can be practically achieved and maintained; in addition the high throughputs cause liquid droplet entrainment which is undesirable where a gaseous product stream is desired. To deal with both of these problems, before exiting the tank the exiting gas is passed through a gas permeable means which is adapted to retard the exit of entrained liquid from the tank, while providing additional intimate contact of the exiting gaseous mixture with the normally liquid chemical material retained thereon.

Preferably, when the heat transfer fluid mixtures of the invention are employed for cooling, they are at moderate temperatures cooler than the object to be cooled or frozen, for example preferably entering the cooling device or area at no more than ambient temperature (about 25° C.), and preferably no higher than about 0° C. When used for heating applications, the inventive heat transfer fluid mixtures preferably enter the heating device or area heated to a temperature above the demand temperature, but below the decomposition temperature of the heavy gas. Very low temperatures, for example, may tend to cause condensation of one or more gases in a mixture and this may not be beneficial insofar as gaseous heat exchange is concerned unless this kind of process is intended as in “heat pipes”.

Alternatively, very high temperatures may cause the decomposition of one or more of the light gases and/or heavy gases in a mixture during a heat exchange process and adversely affect the overall efficiency of the intended heat exchange process due to an unintended change in the original gas mixture composition. On the other hand, if decomposition of a heavy fluid evolves hydrogen, there may be a beneficial effect, as hydrogen has the highest thermal conductivity of all common gases. This could be the case in situations where a heavy fluid such as that known under the trade designation “R-134a” is used. This heavy fluid has the chemical formula of 1,1,1,2-tetrafluorethane. While compounds of this nature are typically quite inert, some decomposition is to be expected at elevated temperatures; see for example the discussion in U.S. Pat. No. 6,254,666, where it is noted that one way to destroy perfluorinated compounds is through thermal destruction. Indeed, in the semiconductor manufacturing art, compounds such as this are employed to produce plasmas, which clean internal surfaces of chemical vapor deposition chambers, and some hydrogen is certainly evolved.

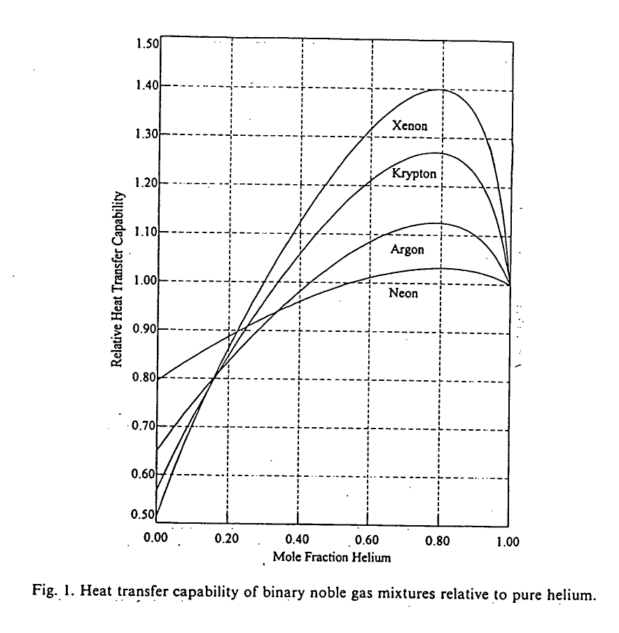

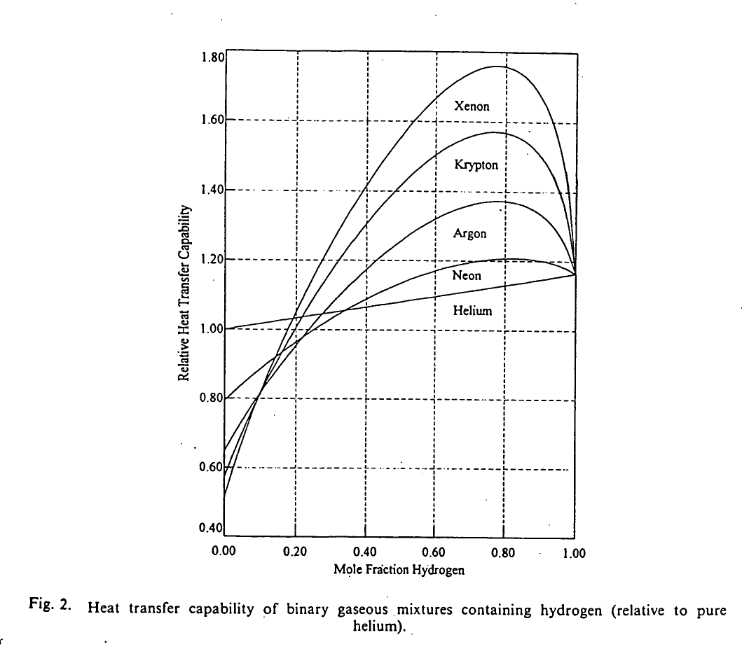

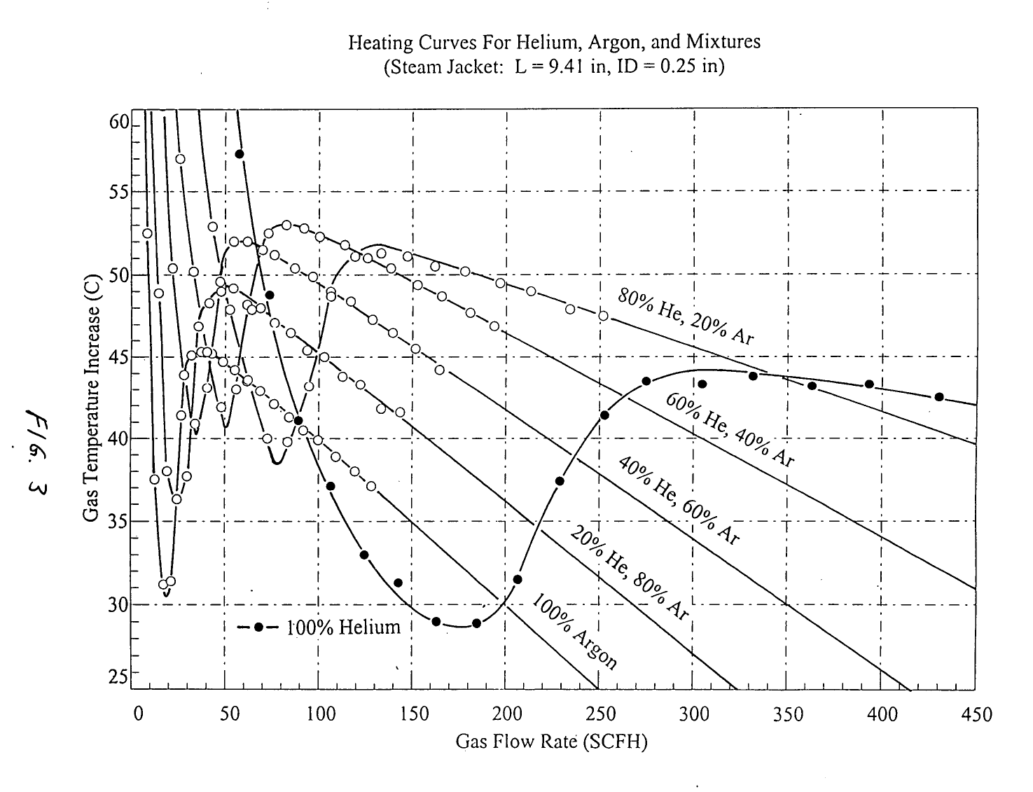

In general, the heat transfer fluid mixtures of the invention are beneficial in any system where a moving or non-moving item is intended to be heated or cooled, either through direct contact with the mixture, or indirect contact such as through a heat exchanger tube wall. In the optical fiber drawing art, the fiber typically moves through a heat exchanger and the gas mixture directly contacts the fiber (see for example FIG. 1 of U.S. Pat. No. 6,125,638, incorporated herein by reference for its teaching of an optical fiber cooling heat exchanger). While the cross flow heat transfer coefficient of a gas flowing past a stationary cylinder has been defined, for example as discussed in Holoboff et al. “Gas Quenching With Helium”, Advanced Materials & Processes, February 1993, there are uncertainties involved in any particular heat transfer system that make prediction difficult. For example, in the fiber drawing art, the optical fiber is moving through a heat exchanger, being drawn by a spool. In one method, the coolant gas typically enters the exchanger at about the mid-point of the fiber in the exchanger, and then splits, some of the gas traveling co-currently with the fiber, and some traveling counter-currently in relation to fiber flow direction, as depicted in the 638 patent.

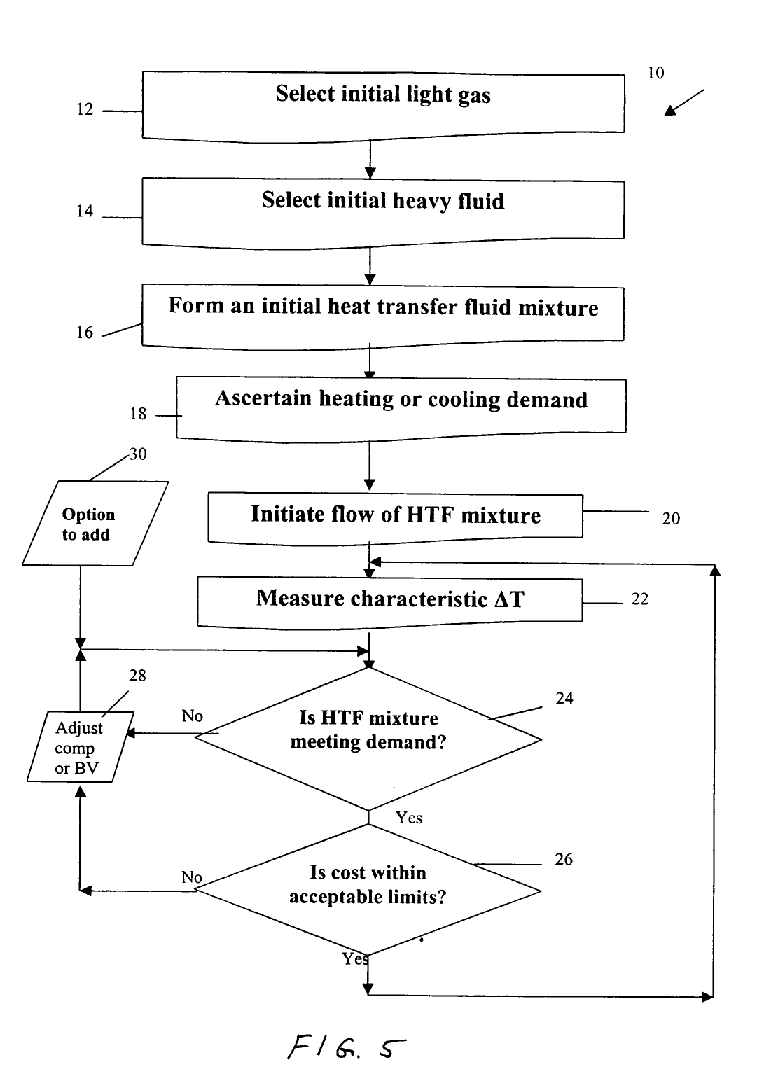

FIG. 5 illustrates one preferred version of a logic diagram 10 for using the inventive heat transfer fluid mixtures of the invention for a heating or cooling process. The particular process is not important to this discussion. More specific examples are offered in the Examples section that follows. First, the light gas and heavy gases are selected, as depicted in boxes 12 and 14. For the moment and for ease of explanation, it will be assumed this is a two-component, or binary heat transfer fluid (HTF) mixture. As discussed herein, depending particularly on the heavy gas, this ideal may be a simplification that is not true, for example when the heavy gas is exposed to conditions that would decompose some or all of the heavy gas. The selection is chosen based on known properties of the item or fluid to be heated or cooled. For example, if the item is a food item to be frozen, then the light gas and heavy gas would be selected from “generally recognized as safe” food grade light gas and heavy gas, for example helium and carbon dioxide.

If the heat transfer process is heat treatment of metal items, the selection is made based on the desired end properties of the metal. An initial HTF mixture is then prepared, either manually or through a computer controlled operation, remotely or locally, as depicted at 16, perhaps an 80 mole percent light gas/20 mole percent heavy gas mixture. A determination is made of the cooling or heating demand for the item being heated or cooled, as illustrated at 18. This determination could be as simple as a human operator decision based on previous experience, or as complex as a computer-controlled thermal analysis using a variety of temperature sensors, feed-forward information on the characteristics of the incoming material to be heated or cooled, and the like.

Once a determination of demand is made, flow of HTF mixture is initiated, as indicated at 20, and a characteristic temperature difference, or ΔT, is measured. The characteristic ΔT could either be based on temperature change of the HTF mixture between an entering point and an exit point of the heat exchange unit, or temperature change of the item being heated or cooled, or a combination. An example of a combination would be, for example, when heat-treating metals. Initially the temperature rise of the metal might be monitored, and then, typically, the temperature of the metal piece is maintained at a certain temperature for minutes or hours. In these circumstances, the ΔT=0 for the metal, so ΔT of the HTF mixture is monitored.

Next, two questions are asked as depicted in the diamond boxes 24 and 26. The first question 24 is whether the heating or cooling demand is being met. If the answer is “yes”, the sequence moves to the second question, and asks if the cost of meeting the demand is within acceptable limits. If the answer to this question is “yes” the HTF mixture is performing as intended in accordance with the invention, and the ΔT is measured again, and the two questions at 24 and 26 are asked again, and so on.

Returning to diamond box 24, if the heating or cooling demand is not being met, then the composition and/or bulk velocity (BV) of the HTF mixture is changed, in accordance with a chart such as illustrated in FIGS. 3 and 4, and the characteristic ΔT is measured again, and the question is asked again, until the heating of cooling demand is being met. If the second question, as depicted in diamond box 26 is answered “no”, then again the logic is that the composition and/or BV of the HTF mixture is modified, in accordance with a chart as in FIGS. 3 and 4, and the two questions are asked again.

One will recognize, after reviewing this disclosure, that the logic of FIG. 5 does not imply that there ever will be a constant composition of the heat transfer fluid mixture (although this condition is not outside the scope of the invention); indeed, understanding this point largely explains a key aspect of the invention. There will tend to be a struggle between cost and meeting the demand.

Another option is to add a third (or more) component to the HTF mixture, as depicted in box 30. Behavior of a mixture containing, for example, two heavy fluids and one light fluid are expected to have heat transfer characteristics similar to an average of the two heavy fluids and the light fluid.

The following prophetic examples demonstrate the range of use of the heat transfer fluid mixtures and methods of the invention.

### EXAMPLES

### Example 1

### Heat Treatment of Metal Parts

A conventional gas-only annealing furnace of the continuous type may be adapted for use with the present invention. Furnaces of this type have previously been achieving a nominal 25-30 ppm residual oxygen level in furnace runs through the use of nitrogen, gaseous argon. This atmosphere typically results in each annealing cycle taking between 3 to 7 hours.

As an example, 800 feet of a 0.100 inch thick, 25 inch wide strip of unalloyed zirconium might be annealed using a heat transfer fluid mixture of the invention, such as a mixture of 85 mole percent helium, 15 mole percent argon. The furnace may easily be prepared to be capable of receiving this mixture. For example, cryogen sources such as 180 liter Dewars of liquified argon stored at a tank pressure of 22 psig, and gaseous helium from a standard gas cylinder may be employed.

The mixture may be delivered to the chamber at a flow rate typically ranging from 0.5 to about 5.0 lb./min. of heat transfer fluid mixture, sufficient to result in a nominal furnace chamber pressure of about 0.8 psig and a residual furnace oxygen concentration of about 10 ppm after a period of minutes. Adjustments of the heat transfer fluid flow rate should allow chamber atmospheres having residual oxygen levels in the single digit ppm range.

If desired, the temperature of the hot/work zone may then be adjusted from a starting temperature of about 400° F. to an operating temperature of about 1600° F. through the use of electric heating elements, for example. The heat transfer fluid mixture flow may be adjusted several times in order to quantify suitable operating parameters and in order to stabilize the pressure over the hot/work zone. These adjustments are typically successful in keeping residual oxygen levels in the single digit ppm range without having to exceed chamber pressures of 5 psig.

### Example 2

### Freezing of Food

Cryogenic individual quick freezing (IQF) apparatus are known in the food freezing art, such as for example that disclosed in U.S. Pat. No. 5,606,861, incorporated herein by reference. IQF apparatus employ cryogenic liquid to efficiently crust freeze or fully freeze food products or other industrial products (such as rubber spheres and the like) of small to medium size (from about 1 millimeter diameter to about 5 centimeters in diameter for roughly spherical items, such as plums). The food or other industrial product is preferably of a size and shape such that it can be moved in two or three dimensions. For example, food products that may be IQF include shrimp, peas, diced meat, and meatballs. Examples of products that probably would not be preferred include hamburger patties, packaged food, and, due to the fragility and dimension ratios, products like tortillas and potato chips.

IQF apparatus would preferably use direct contact of the heat transfer fluid mixtures of the invention to cool the product as it travels through a freezing chamber along a product support, preferably employing a moving conveyor belt. It should be understood, however, that a moving conveyor belt is not necessary in all embodiments; a stationary table can be used. This is because in some preferred embodiments a plurality of blowers are positioned on either side of the product support to agitate the product, move the product across the product support, and to cool the product as it passes through freezing chamber from a product entrance to a product exit.

In preferred embodiments, the heat transfer fluid mixture would be sprayed directly into a freezing chamber, and a freezer housing would completely enclose and contain the heta transfer fluid mixture so that the only openings provided would be a product entrance and a product exit at either end of the IQF freezer apparatus.

Blowers mounted in recirculation chambers each have an inlet preferably on the upper surface thereof and an outlet in one of side walls of the IQF freezing chamber. Blowers draw the heat transfer fluid mixture from the freezing chamber and recirculate it across the product on conveyor belt. Blower outlets direct the heat transfer fluid mixture laterally across the conveyor belt directly on the product, causing the product both to be cooled and to be agitated or blown across and/or over the conveyer belt at the same time by the force of the gas. In embodiments where the heat transfer fluid mixture is sprayed directly into freezing chamber, the injectors are preferably positioned in the blower exits of the first blowers. Blowers may be single speed or variable speed, depending on factors such as product size and shape, whether two dimensional or three dimensional translation is desired, and the like.

Although it is possible to use single speed motors in the blowers, it is more preferable to employ variable speed “squirrel cage” blowers. A variable speed blower having a 2 horsepower motor with a 13.5 inch (34.3 cm) radial blade rotating at 1725 rpm is sufficient to agitate a plurality of individual product pieces, each having an average diameter ranging from about 0.5 centimeter up to about 5 centimeters, and density ranging from about 0.7 to about 2.0 grams per cubic centimeter, across an 18 inch (45.7 cm) wide horizontal conveyor belt. Blowers of this and other sizes are available from Dayton Blower Co., Dayton, Ohio. However, a wide range of blower size to belt width ratios are also possible and are within the scope of the invention. Heat transfer fluid mixture injectors would preferably spray the mixture directly on the food or other products that are passing along the conveyor belt in front of the blower outlets. In some embodiments, one or more heat transfer fluid mixture control valves may be positioned upstream of the injectors, the control valves operated through a temperature control system to control the volume of mixture flowing through the injectors.

### Example 3

### Freezing of Foods

U.S. Pat. No. 5,921,091, incorporated by herein by reference, discloses an example of a straight tunnel freezer which may benefit from the teachings of the present invention. As illustrated in FIG. 1 of the 091 patent, a straight tunnel freezer includes an elongated freezer tunnel and a conveyor on which a food product is transported from a freezer entrance to a freezer exit. One or more coolant nozzles are provided within the tunnel, preferably near the entrance of the tunnel. Coolant nozzles preferably direct a mixture of liquid nitrogen and liquid oxygen directly onto the product. Alternatively, coolant nozzles may be provided in the tunnel without directing the coolant directly on the food product. In this case, the cool gas mixture within the tunnel is circulated around the food product by means of fans or blowers. One or more fans may also be provided within the tunnel either above, below or at a side of the conveyor belt for circulating the cold gases within the freezer.

The 091 patent teaches the use of mixtures of oxygen and nitrogen to form “synthetic air”. These two fluids would serve as heavy fluids in the present invention, while a light gas would preferably be helium. The amount of helium provided from a helium supply and an amount of oxygen or nitrogen from a source of same are controlled by flow control valves 26, 28. Valves 26, 28 may be controlled by a controller 30 to achieve the desired cryogenic mixture, preferably of 18% to 25% oxygen. Valves 26, 28 may also be controlled manually.

In order to assure safe working conditions for workers within the room in which the freezer is located, one or more oxygen level sensors 32 are preferably provided within the room. Instead of being located within the room in which the freezing chamber is located, an information of oxygen level could also be taken at one or more locations inside the freezing chamber.

The information from these oxygen level sensors 32 may be used by controller 30 to control the mixture of nitrogen and oxygen by varying, when necessary, the flow rates with valves 26, 28. Preferably, an alarm 34 is provided which is activated by controller 30 when the oxygen level in the room drops below acceptable levels.

In the embodiment of FIG. 1, the mixture of nitrogen and oxygen is mixed by valves 26, 28 just prior to use in freezer tunnel 10. The mixture may also be mixed within freezer tunnel 10 by providing two separate nozzles for liquid nitrogen and liquid oxygen. According to an alternative embodiment, the mixture may be premixed rather than mixed at the entrance to the freezer. However, degradation of a pre-mixed liquid will occur as a function of both pressure and time. The oxygen concentration of a premixed liquid will continue to increase over time and the rate of change will increase with higher pressure. Therefore, for safety reasons a premixed product would preferably be mixed at an on-site plant.

### Example 4

### Cooling of Optical Fibers

Production of optical fibers typically employs helium or hydrogen to dry glass preforms during consolidation, for drawing the fiber during heating, and for cooling the drawn fiber, especially if the fiber is to be coated with a resin for toughening the fiber, and making it more resistant to fatigue, abrasion, and the like. U.S. Pat. No. 6,092,391 discloses some details of a consolidation furnace. This patent discloses the use of a sensor (either composition, P, T, or flow rate) on the exhaust stream. Another patent, U.S. Pat. No. 5,284,499, discloses how a glass preform is drawn through a heating element, a diameter measuring device, and a muffle tube. The cooling gases (He or Ar) flows into the top of the tube in this arrangement, and is heated as it passes into contact with the fiber, which is typically at a temperature of about 2100-2300° C. The fiber is typically drawn under tension of about 9 grams, at a draw rate of about 9 meters/second. The gas flow rate is disclosed to be about 3 slpm. In this patent, it is preferred to keep a boundary layer of gas near the fiber to thus maintain the boundary layer and prevent air currents, which might produce “bow” (fiber bending) and “airline” (small holes in the fiber).

Other patents in the area of optical fiber manufacturing interestingly call for more turbulent flow of the gas to cool the fiber as quickly as possible so that resins may be applied. Representative of this is U.S. Pat. No. 4,437,870. The first mention of helium used in optical fiber manufacture as a coolant appears to be U.S. Pat. No. 4,154,592, where it was recognized that helium apparently reduced thermal gradients due to its higher thermal conductivity compared to oxygen and nitrogen. Mixtures of helium/oxygen/nitrogen were discussed. Another interesting patent is U.S. Pat. No. 5,059,229, which discloses the use of helium/hydrogen mixtures, but no mention of the heat transfer effects. The point was to introduce hydrogen into the coolant gas to prevent “transient hydrogen sensitive attenuation.” There was no recognition in any of these patents of heat transfer fluid mixtures that could be changed in composition and/or flow rate (bulk velocity) to achieve both lower cost and more effective cooling.

The present heat transfer fluid mixtures can be advantageously employed in optical fiber consolidation, drawing, and fiber cooling to decrease costs while achieving almost the same cooling as pure helium. Depending on the process, the light gas is first selected, for example helium, then a heavy fluid, such as Ar, and the cooling demand determined. The composition is then adjusted, either by adding more argon or more helium, or an optional third fluid, such as carbon dioxide, and/or by adjusting the bulk velocity, and the cost also calculated for operating using the adjusted gas composition. If the cooling demand is still being met, and the cost is within acceptable limits, the adjusted gas composition and bulk velocity is maintained. If not, they are changed. The changes employ a computer stored version of the heat transfer data for example as depicted in FIG. 3 for the argon/helium system.

The scope of the claims that follow is not intended to be limited by the description of preferred embodiments. Those skilled in the heat transfer art, after reading this disclosure, will recognize that the inventive compositions and methods are useful in a variety of heating and cooling applications.

1. A heat transfer fluid mixture consisting essentially of at least one light gas and at least one heavy gas, each of the at least one heavy gases having molecular weight at least two times that of each of the at least one light gas.

2. The heat transfer fluid mixture of claim 1 wherein the at least one light gas has a molecular weight less than 10, and the at least one heavy gas has a molecular weight of 10 or greater.

3. The heat transfer fluid mixture of claim 1 wherein the at least one light gas is hydrogen and the at least one heavy gas is helium.

4. The heat transfer fluid mixture of claim 1 wherein the at least one light gas is selected from the group consisting of hydrogen, helium, and mixtures thereof.

5. The heat transfer fluid mixture of claim 1 wherein the at least one light gas is hydrogen and the at least one heavy gas is selected from the group consisting of helium, any single fluid heavier than helium, and any mixture thereof.

6. The heat transfer fluid mixture of claim 1 wherein the at least one light gas is selected from the group consisting of hydrogen, helium, and any mixture thereof, and the heavy gas is selected from the group consisting of argon, any single fluid heavier than helium, and any mixture of fluids heavier than helium.

7. The heat transfer fluid mixture of claim 1 wherein the at least one light gas has a concentration ranging from about 1 mole percent to about 99 mole percent.

8. The heat transfer fluid mixture of claim 1 wherein the at least one light gas has a concentration ranging from about 30 mole percent to about 98 mole percent.

9. The heat transfer fluid mixture of claim 1 wherein the at least one light gas has a concentration ranging from about 40 mole percent to about 97 mole percent.

10. The heat transfer fluid mixture of claim 1 wherein the at least one light gas has a concentration ranging from about 50 mole percent to about 96 mole percent.

11. The heat transfer fluid mixture of claim 1 wherein the at least one light gas has a concentration ranging from about 60 mole percent to about 95 mole percent.

12. The heat transfer fluid mixture of claim 1 wherein the at least one heavy gas is selected from the group consisting of CCl₃F, CCl₂F₂, CClF₃, CBrF₃, CF₄, CHCl₂F, CHClF₂, CHF₃, C₂Cl₄F₂, C₂Cl₃,F₃, C₂Cl₂F₄, C₂Br₂F₄, C₂ClF₅, C₂F₆, C₂H₄F₂, C₂H₂F₄ and mixtures thereof.

13. The heat transfer fluid mixture of claim 1 wherein the at least one heavy gas is selected from the group consisting of N₂, o₂, F₂, Ne, Cl₂, Ar, Br₂, Kr, Xe, and Rn.

14. The heat transfer fluid mixture of claim 1 wherein the at least one heavy gas is selected from the group consisting of CH₄, C₂H₄, C₂H₆, C₃H₈, C₃H₆, C₄H₁₀, (CH₃)₃CH, NH₃, CO, CO₂, CCl₄, CH₃Cl, SO₂, SO₃, NO, NO₂, N₂O, and mixtures thereof.

15. The heat transfer fluid mixture of claim 1 wherein the at least one heavy gas is selected from the group consisting of N₂, o₂, F₂, Ne, Cl₂, Ar, Br₂, Kr, Xe, Rn, CH₄, C₂H₄, C₂H₆, C₃H₈, C₃H₆, C₄H₁₀, (CH₃)₃CH, NH₃, CO, CO₂, CCl₄, CH₃Cl, SO₂, SO₃, NO, NO₂, N₂O, CCl₃F, CCl₂F₂, CClF₃, CBrF₃, CF₄, CHCl₂F, CHClF₂, CHF₃, C₂Cl₄F₂, C₂Cl₃,F₃, C₂Cl₂F₄, C₂Br₂F₄, C₂ClF₅, C₂F₆, C₂H₄F₂, C₂H₂F₄, and mixtures thereof.

16. The heat transfer fluid mixture of claim 1 wherein each of the at least one heavy gases has molecular weight at least five times that of each of the at least one light gas.

17. The heat transfer fluid mixture of claim 15 wherein the at least one light gas has a concentration ranging from about 20 mole percent to about 99 mole percent.

18. The heat transfer fluid mixture of claim 15 wherein the at least one light gas has a concentration ranging from about 30 mole percent to about 98 mole percent.

19. The heat transfer fluid mixture of claim 15 wherein the at least one light gas has a concentration ranging from about 40 mole percent to about 97 mole percent.

20. A method of cooling an item, the method comprising contacting the item with the mixture of claim 1, wherein said contacting is selected from the group consisting of directly contacting, indirectly contacting, and combinations thereof.

21. A method of cooling an item, the method comprising contacting the item with the mixture of claim 2 wherein said contacting is selected from the group consisting of directly contacting, indirectly contacting, and combinations thereof.

22. A method of cooling an item, the method comprising contacting the item with the mixture of claim 3 wherein said contacting is selected from the group consisting of directly contacting, indirectly contacting, and combinations thereof.

23. A method of cooling an item, the method comprising contacting the item with the mixture of claim 4 wherein said contacting is selected from the group consisting of directly contacting, indirectly contacting, and combinations thereof.

24. A method of cooling an item, the method comprising contacting the item with the mixture of claim 5 wherein said contacting is selected from the group consisting of directly contacting, indirectly contacting, and combinations thereof.

25. A method of cooling an item, the method comprising contacting the item with the mixture of claim 6 wherein said contacting is selected from the group consisting of directly contacting, indirectly contacting, and combinations thereof.

26. A method of heating an item, the method comprising contacting the item with the mixture of claim 1 wherein said contacting is selected from the group consisting of directly contacting, indirectly contacting, and combinations thereof.

27. A method of heating an item, the method comprising contacting the item with the mixture of claim 2 wherein said contacting is selected from the group consisting of directly contacting, indirectly contacting, and combinations thereof.

28. A method of heating an item, the method comprising contacting the item with the mixture of claim 3 wherein said contacting is selected from the group consisting of directly contacting, indirectly contacting, and combinations thereof.

29. A method of heating an item, the method comprising contacting the item with the mixture of claim 4 wherein said contacting is selected from the group consisting of directly contacting, indirectly contacting, and combinations thereof.

30. A method of heating an item, the method comprising contacting the item with the mixture of claim 5 wherein said contacting is selected from the group consisting of directly contacting, indirectly contacting, and combinations thereof.

31. A method of heating an item, the method comprising contacting the item with the mixture of claim 6 wherein said contacting is selected from the group consisting of directly contacting, indirectly contacting, and combinations thereof.

32. A method of cooling an item traversing through a substantially confined space, the method comprising contacting the item with the mixture of claim 1 wherein said contacting is selected from the group consisting of directly contacting, indirectly contacting, and combinations thereof.

33. A method of cooling an item traversing through a substantially confined space, the method comprising contacting the item with the mixture of claim 2 wherein said contacting is selected from the group consisting of directly contacting, indirectly contacting, and combinations thereof.

34. A method of cooling an item traversing through a substantially confined space, the method comprising contacting the item with the mixture of claim 3 wherein said contacting is selected from the group consisting of directly contacting, indirectly contacting, and combinations thereof.

35. A method of cooling an item traversing through a substantially confined space, the method comprising contacting the item with the mixture of claim 4 wherein said contacting is selected from the group consisting of directly contacting, indirectly contacting, and combinations thereof.

36. A method of cooling an item traversing through a substantially confined space, the method comprising contacting the item with the mixture of claim 5 wherein said contacting is selected from the group consisting of directly contacting, indirectly contacting, and combinations thereof.

37. A method of cooling an item traversing through a substantially confined space, the method comprising contacting the item with the mixture of claim 6 wherein said contacting is selected from the group consisting of directly contacting, indirectly contacting, and combinations thereof.

38. A method of heating an item traversing through a substantially confined space, the method comprising contacting the item with the mixture of claim 1 wherein said contacting is selected from the group consisting of directly contacting, indirectly contacting, and combinations thereof.

39. A method of heating an item traversing through a substantially confined space, the method comprising contacting the item with the mixture of claim 2 wherein said contacting is selected from the group consisting of directly contacting, indirectly contacting, and combinations thereof.

40. A method of heating an item traversing through a substantially confined space, the method comprising contacting the item with the mixture of claim 3 wherein said contacting is selected from the group consisting of directly contacting, indirectly contacting, and combinations thereof.

41. A method of heating an item traversing through a substantially confined space, the method comprising contacting the item with the mixture of claim 4 wherein said contacting is selected from the group consisting of directly contacting, indirectly contacting, and combinations thereof.

42. A method of heating an item traversing through a substantially confined space, the method comprising contacting the item with the mixture of claim 5 wherein said contacting is selected from the group consisting of directly contacting, indirectly contacting, and combinations thereof.

43. A method of heating an item traversing through a substantially confined space, the method comprising contacting the item with the mixture of claim 6 wherein said contacting is selected from the group consisting of directly contacting, indirectly contacting, and combinations thereof.

44. A method of cooling a substantially cylindrical item traversing through a substantially confined space, the method comprising contacting the substantially cylindrical item with the mixture of claim 1 wherein said contacting is selected from the group consisting of directly contacting, indirectly contacting, and combinations thereof.

45. A method of cooling a substantially cylindrical item traversing through a substantially confined space, the method comprising contacting the substantially cylindrical item with the mixture of claim 2 wherein said contacting is selected from the group consisting of directly contacting, indirectly contacting, and combinations thereof.

46. A method of cooling a substantially cylindrical item traversing through a substantially confined space, the method comprising contacting the substantially cylindrical item with the mixture of claim 3 wherein said contacting is selected from the group consisting of directly contacting, indirectly contacting, and combinations thereof.

47. A method of cooling a substantially cylindrical item traversing through a substantially confined space, the method comprising contacting the substantially cylindrical item with the mixture of claim 4 wherein said contacting is selected from the group consisting of directly contacting, indirectly contacting, and combinations thereof.

48. A method of cooling a substantially cylindrical item traversing through a substantially confined space, the method comprising contacting the substantially cylindrical item with the mixture of claim 5 wherein said contacting is selected from the group consisting of directly contacting, indirectly contacting, and combinations thereof.

49. A method of cooling a substantially cylindrical item traversing through a substantially confined space, the method comprising contacting the substantially cylindrical item with the mixture of claim 6 wherein said contacting is selected from the group consisting of directly contacting, indirectly contacting, and combinations thereof.

50. A method of heating a substantially cylindrical item traversing through a substantially confined space, the method comprising contacting the substantially cylindrical item with the mixture of claim 1 wherein said contacting is selected from the group consisting of directly contacting, indirectly contacting, and combinations thereof.

51. A method of heating a substantially cylindrical item traversing through a substantially confined space, the method comprising contacting the substantially cylindrical item with the mixture of claim 2 wherein said contacting is selected from the group consisting of directly contacting, indirectly contacting, and combinations thereof.

52. A method of heating a substantially cylindrical item traversing through a substantially confined space, the method comprising contacting the substantially cylindrical item with the mixture of claim 3 wherein said contacting is selected from the group consisting of directly contacting, indirectly contacting, and combinations thereof.

53. A method of heating a substantially cylindrical item traversing through a substantially confined space, the method comprising contacting the substantially cylindrical item with the mixture of claim 4 wherein said contacting is selected from the group consisting of directly contacting, indirectly contacting, and combinations thereof.

54. A method of heating a substantially cylindrical item traversing through a substantially confined space, the method comprising contacting the substantially cylindrical item with the mixture of claim 5 wherein said contacting is selected from the group consisting of directly contacting, indirectly contacting, and combinations thereof.

55. A method of heating a substantially cylindrical item traversing through a substantially confined space, the method comprising contacting the substantially cylindrical item with the mixture of claim 6 wherein said contacting is selected from the group consisting of directly contacting, indirectly contacting, and combinations thereof.

56. A method of cooling a substantially cylindrical optical fiber traversing through a heat exchanger, the method comprising directly contacting the optical fiber with the mixture of claim 1.

57. A method of cooling a substantially cylindrical optical fiber traversing through a heat exchanger, the method comprising directly contacting the optical fiber with the mixture of claim 2.

58. A method of cooling a substantially cylindrical optical fiber traversing through a heat exchanger, the method comprising directly contacting the optical fiber with the mixture of claim 3.

59. A method of cooling a substantially cylindrical optical fiber traversing through a heat exchanger, the method comprising directly contacting the optical fiber with the mixture of claim 4.

60. A method of cooling a substantially cylindrical optical fiber traversing through a heat exchanger, the method comprising directly contacting the optical fiber with the mixture of claim 5.

61. A method of cooling a substantially cylindrical optical fiber traversing through a heat exchanger, the method comprising directly contacting the optical fiber with the mixture of claim 6.

62. A method of improving the cooling of a substantially cylindrical optical fiber traversing through a heat exchange device, the method comprising the steps of directly contacting the optical fiber with a heat transfer fluid mixture consisting essentially of at least one light gas and at least one heavy gas, and making an adjustment (either intermittently or continuously) of a parameter during the cooling, the parameter selected from the group consisting of composition of the heat transfer fluid mixture, flow rate of the heat transfer fluid mixture into the heat exchange device, an amount of heat transfer fluid mixture contacting the fiber in counter-current fashion, an amount of heat transfer fluid mixture contacting the fiber in co-current fashion, composition of the heat transfer fluid mixture contacting the fiber in counter-current fashion, composition of the heat transfer fluid mixture contacting the fiber in co-current fashion, a temperature of the heat transfer fluid mixture being injected into the heat exchange device, a temperature of the heat transfer fluid mixture before contacting the fiber in counter-current fashion, a temperature of the heat transfer fluid mixture during contacting the fiber in counter-current fashion, a temperature of the heat transfer fluid mixture after contacting the fiber in counter-current fashion, a temperature of the heat transfer fluid mixture before contacting the fiber in a co-current fashion, a temperature of the heat transfer fluid mixture during contacting the fiber in a co-current fashion, a temperature of the heat transfer fluid mixture after contacting the fiber in a co-current fashion, a pressure of the heat transfer fluid mixture injected into the heat exchange device, a pressure of the heat transfer fluid mixture contacting the fiber in countercurrent fashion, and a pressure of the heat transfer fluid mixture contacting the fiber in a co-current fashion.

63. A method of improving cooling of an object in contact with a stagnant or flowing gas mixture in a confined space, the method comprising contacting the object with a heat transfer fluid mixture consisting essentially of at least one light gas and at least one heavy gas, the contacting being selected from the group consisting of directly contacting, indirectly contacting, and combinations thereof, and making an adjustment either intermittently or continuously of a parameter during the cooling process, the parameter selected from the group consisting of a composition of the heat transfer fluid mixture, a flow rate of the heat transfer fluid mixture in contact with the object, an amount of heat transfer fluid mixture contacting the object, a composition of the heat transfer fluid mixture contacting the object, a temperature of the heat transfer fluid injected into the confined space, a temperature of the heat transfer fluid mixture before contacting the object, a temperature of the heat transfer fluid mixture during contacting the object, a temperature of the heat transfer fluid mixture after contacting the object, a pressure of the heat transfer fluid mixture entering the confined space, and a pressure of the heat transfer fluid mixture contacting the object.

64. The method of claim 63 wherein said parameter adjustment is made automatically or manually based upon a measured parameter of the object that changes during the cooling process.

65. A method of improving heating of an object in contact with a stagnant or flowing gas mixture in a confined space, the method comprising contacting the object with a heat transfer fluid mixture consisting essentially of at least one light gas and at least one heavy gas, the contacting being selected from the group consisting of directly contacting, indirectly contacting, and combinations thereof, and making an adjustment either intermittently or continuously of a parameter during the heating process, the parameter selected from the group consisting of a composition of the heat transfer fluid mixture, a flow rate of the heat transfer fluid mixture in contact with the object, an amount of heat transfer fluid mixture contacting the object, a composition of the heat transfer fluid mixture contacting the object, a temperature of the heat transfer fluid injected into the confined space, a temperature of the heat transfer fluid mixture before contacting the object, a temperature of the heat transfer fluid mixture during contacting the object, a temperature of the heat transfer fluid mixture after contacting the object, a pressure of the heat transfer fluid mixture entering the confined space, and a pressure of the heat transfer fluid mixture contacting the object.

66. The method of claim 65 wherein said parameter adjustment is made automatically or manually based upon a measured parameter of the object that changes during the heating process.

67. A method of making a heat transfer fluid, the heat transfer fluid adjustable between a first composition having high heat transfer coefficient and high cost of use, and a second composition having essentially the same heat transfer coefficient as the first composition but allowing reduced cost of use, the method comprising the steps of:

68. providing at least one light gas from a light gas source;

69. providing at least one heavy gas from a heavy gas or fluid source;

70. ascertaining a heating or cooling demand;

71. combining the at least one light gas and the at least one heavy gas or fluid based on said demand.

72. The method of claim 67 wherein said demand is a cooling demand.

73. The method of claim 67 wherein said demand is a heating demand.

74. The method of claim 67 wherein each of the at least one heavy gases has a molecular weight at least two times that of each of the at least one light gas.

75. The method of claim 67 wherein said light gas is selected from the group consisting of hydrogen, helium, and any mixture thereof, and the heavy gas is selected from the group consisting of argon, any single fluid heavier than helium, and any mixture of fluids heavier than helium.

76. The method of claim 67 wherein the at least one heavy gas is selected from the group consisting of N₂, o₂, F₂, Ne, Cl₂, Ar, Br₂, Kr, Xe, Rn, CH₄, C₂H₄, C₂H₆, C₃H₈, C₃H₆, C₄H₁₀, (CH₃)₃CH, NH₃, CO, CO₂, CCl₄, CH₃Cl, SO₂, SO₃, NO, NO₂, N₂O, CCl₃F, CCl₂F₂, CClF₃, CBrF₃, CF₄, CHCl₂F, CHClF₂, CHF₃, C₂Cl₄F₂, C₂Cl₃,F₃, C₂Cl₂F₄, C₂Br₂F₄, C₂ClF₅, C₂F₆, C₂H₄F₂, C₂H₂F₄, and mixtures thereof.
